(19) United States
(12) Patent Application Publication
(10) Pub. No.: US 2014/0293914 A1
(43) Pub. Date: Oct. 2, 2014

(54) Scheduling

(71) Applicant: Broadcom Corporation, Irvine, CA (US)

(72) Inventors: Helka-Liina MAATTANEN, Helsinki (FI); Mihai Horatiu ENESCU, Espoo (FI); Tero Heikki Matti HENTTONEN, Espoo (FI)

(73) Assignee: Broadcom Corporation, Irvine, CA (US)

(21) Appl. No.: 14/243,430

(22) Filed: Apr. 2, 2014

(30) Foreign Application Priority Data
Apr. 2, 2013 (GB) 1305935.7

(51) Int. Cl. H04W 72/12; H04L 5/00

(52) U.S. Cl. CPC H04W 72/1278; H04L 5/0053
USPC 370/329

(57) ABSTRACT

A method and apparatus for distributed coordinated scheduling (virtual joint scheduling) is provided. A primary entity is selected and it performs joint scheduling decisions according to information received from one or more coordinating secondary entities. Information received from user equipments served by the primary entity may be taken into account. The primary entity then forwards information of its joint scheduling decisions or some outcome quantity to the one or more secondary entities, each of which may perform their own localized scheduling decisions based on the information provided by the primary entity.

### TECHNICAL FIELD

The present invention relates to joint scheduling. In particular, but not exclusively, the present invention relates to apparatus, methods, and computer program products related to virtual joint scheduling in distributed systems.

### BACKGROUND

List of Abbreviations:
3 GPP 3^{rd} Generation Partnership Project
ABS Almost Blank Subframe
AP Application Protocol
BS Base Station
CB Coordinated Beamforming
CoMP Coordinated Multipoint Transmission/Reception
CQI Channel Quality Indicator
CS Coordinated Scheduling
CSI Channel State Information
CSI-RS CSI—Reference Symbol
DPB Dynamic Point Blanking
eNB enhanced Node-B
ICIC Inter-Cell Interference Coordination
IE Information Element
IM-RS Interference Measurement—Reference Symbol
JP Joint Processing
LTE™ Long Term Evolution
LTE-A Long Term Evolution Advanced
MBSFN Multimedia Broadcast multicast service Single Frequency Network
MIMO Multiple-Input Multiple-Output
MU Multi-User
PMI Precoding Matrix Indicator
PRB Physical Resource Block
Rel Release
RI Rank Indicator
RNTP Relative Narrowband Tx Power
RS Reference Symbol
RRM Radio Resource Management
SINR Signal to Interference and Noise Ratio
SU Single-User
TP Transmission Point
TR Technical Report
TS Technical Specification
UE User Equipment

In the 3^{rd} Generation Partnership Project (3GPP) Long Term Evolution (LTE) and LTE-Advanced (LTE-A), single cell single-user (SU-) and multi-user (MU-) multiple-input multiple-output (MIMO) network performance is interference-limited, especially at the cell edge. Therefore, introduction of the technology of coordinated multipoint (CoMP) transmission/reception has been considered, where in downlink, multiple points (which in practice may be base stations) co-operate in scheduling and transmission in order to strengthen desired signal and mitigate inter-cell interference. According to the 3GPP technical report on CoMP, TR 36.819, a point is a set of geographically co-located transmit antennas and the sectors of the same site correspond to different points. It should be noted that a cell is formed by one or multiple points, meaning that one cell can comprise transmit antennas distributed in multiple geographical locations.

Release 11 specifications provide a feedback framework allowing the implementation of several CoMP schemes: joint transmission, dynamic point selection, including dynamic point blanking, and coordinated scheduling/beamforming, including dynamic point blanking In joint transmission (JT) CoMP two or more points transmit simultaneously to a CoMP user. Dynamic point selection (DPS) refers to a scheme where the transmission point is switched according to changes in channel and interference conditions. In coordinated scheduling/coordinated beamforming (CS/CB) the scheduling decisions of neighbor points are coordinated in order to reduce interference. In Release 11, the main assumption is that CoMP is performed within a scenario where transmission points have fiber connections while also the backhaul is assumed to be ideal, i.e. does not cause significant delays. In Release 12, there is a work item description for enhanced CoMP that includes non-ideal backhaul assumptions. Thus, the X2 interface, which is an interface between different eNBs, may be utilized.

The non-ideal backhaul introduces delays, and depending on the length of the delay the operation of such CoMP schemes that require the user data to be synchronized in more than one point becomes more difficult or impossible. The synchronization problems add to the delay imbalance that already exists when the transmission points are geographically separated. CoMP schemes most prominent to work over non-ideal backhaul are different interference coordination methods like CS/CB and different muting or power reduction schemes.

Another issue of relevance is whether a centralized scheduling unit is used for the cooperating points, as it is assumed for Release 11, or whether the cooperating transmission points have their own scheduling units. The latter case is more probable when usage of an X2 interface is assumed between the points.

An initial problem that CoMP is intended to mitigate is the performance of cell edge users, as especially at cell edge the performance is interference-limited. The CoMP operation specified in Release 11 assumes ideal fiber connection between the points that may cooperate and this facilitates the operation of non-coherent JT and DPS as well as iterative CS/CB CoMP methods. The effects of a non-ideal backhaul and the X2 interface are to be evaluated in Release 12. The X2 interface is a protocol stack defined in the LTE standard for connecting eNBs in a peer-to-peer way, see TS 36.423, X2 application protocol (X2AP). The purpose of the X2 interface is to enable eNBs of different vendors to cooperate and it defines for example handover procedures.

The X2 interface can be envisioned between CoMP clusters but it is also possible to have X2 within, for example, scenario 4 of TS 36.819, section 5.1.2, wherein there are several pico cells inside the coverage area of a macro cell, all sharing the same cell ID. In this scenario, the macro cells and pico cells may be from different vendors. The problem boils down to the cooperation of two scheduling units which communicate over the X2 interface or some other interface alike. Current specifications include signaling details enabling a simple form of inter-cell interference coordination (ICIC). For details, see the prior art further below. In Release 12, both the effects of a non-ideal backhaul as the CoMP over X2 are to be studied.

Typically, eNB to eNB communications consists only of recommendations or requests; however there are no means to control the other eNB. However, the scenario where pico cells/eNB would be placed in the coverage area of a macro cell/eNB (e.g. of a different vendor) may be a typical case. It may be required to define some sort of rules between the eNBs to have a fair operation.

Prior art related to coordinated scheduling is outlined hereinafter. Coordinated scheduling/coordinated beamforming means schemes where cooperating base stations aim to schedule users such that the intercell interference is minimized. One option is that the eNBs select the PMI vectors of the scheduled users such that the interference is minimized. This requires that the PMIs causing strong interference are known. Another option is to perform power control which may mean muting on certain PRBs. PMI coordination is mentioned in the following articles:
R. Irmer et al.: “Coordinated Multipoint: Concepts, Performance, and Field Trial Results”, IEEE Communications Magazine, February 2011, pages 102 to 111; and
H. Taoka et al.: “MIMO and CoMP in LTE-Advanced”, NTT Docomo Technical Journal, Vol. 12, No. 2, pages 20 to 28.

In 3GPP the distributed scheduling problem has been discussed mainly from the total delay point of view in the context of X2 discussions. Here is one example with a scheduling scheme description: 3GPP R1-110719 of CATT, where a distributed scheduling example is described. In that scheme, TP1 makes scheduling decisions independently and communicates these scheduling decisions to TP2, which then makes its own decisions and sends those back to TP1. The scheme is iterative. Also a non-iterative option is described in which the TP1 sends the scheduling decisions and waits for a time T for the other point to take the scheduling decisions into account. In this and other contributions the view on the backhaul capacity is that it is in general enough for communicating scheduling decisions but fiber is needed if user data needs to be backhauled between eNBs.

A related patent is EP2503837A1 of ZTE, where a centralized scheduling is described as a coordinated scheduling scheme. One cell is selected as a central cell and other cells only collect user feedback which is further forwarded to the central cell. EP2503837A1 describes in practice the Rel. 11 operation where a central entity performs the proportional fair (PF) scheduling of all cooperating points.

Another related patent is US2012/0238283A1 of ZTE, where a priority sequencing on each coordinated cell according to the historical and/or current information of each coordinated cell is disclosed. This is a kind of scheduling of the scheduling turns of the coordinated cells. It means that there is a control entity that gives each cell a turn to schedule users connected to that cell according to some sort of “scheduling turn metric”. It is expected that other cells will then be aware of the scheduling decisions made by a cell that has already performed the scheduling. It is a kind of consecutive scheduling as in the 3GPP R1-110719 described above.

In the existing specification for X2, TS 36.423 X2 application protocol (X2AP), some features are described that can be used for inter-eNB interference coordination. These are described in Section 8.3.1.2 of v11.1.0 (2012-06):
An eNB initiates the procedure by sending LOAD INFORMATION message to eNBs controlling intra frequency neighboring cells.
If the UL Interference Overload Indication IE is received in the LOAD INFORMATION message, it indicates the interference level experienced by the indicated cell on all resource blocks, per PRB. The receiving eNB may take such information into account when setting its scheduling policy and shall consider the received UL Interference Overload Indication IE value valid until reception of a new LOAD INFORMATION message carrying an update of the same IE.
If the UL High Interference Indication IE is received in the LOAD INFORMATION message, it indicates, per PRB, the occurrence of high interference sensitivity, as seen from the sending eNB. The receiving eNB should try to avoid scheduling cell edge UEs in its cells for the concerned PRBs. The Target Cell ID IE received within the UL High Interference Information IE group in the LOAD INFORMATION message indicates the cell for which the corresponding UL High Interference Indication is meant. The receiving eNB shall consider the value of the UL High Interference Information IE group valid until reception of a new LOAD INFORMATION message carrying an update.

These two are used for uplink interference control. An eNB can measure directly the uplink interference/interference sensitivity and may send the indication over X2 accordingly.
If the Relative Narrowband Tx Power (RNTP) IE is received in the LOAD INFORMATION message, it indicates, per PRB, whether downlink transmission power is lower than the value indicated by the RNTP Threshold IE. The receiving eNB may take such information into account when setting its scheduling policy and shall consider the received Relative Narrowband Tx Power (RNTP) IE value valid until reception of a new LOAD INFORMATION message carrying an update.
If the ABS Information IE is included in the LOAD INFORMATION message, the ABS Pattern Info IE indicates the subframes designated as almost blank subframes by the sending eNB for the purpose of interference coordination. The receiving eNB may take such information into consideration when scheduling UEs.
The receiving eNB may use the Measurement Subset IE received in the LOAD INFORMATION message, for the configuration of specific measurements towards the UE.
The receiving eNB shall consider the received information as immediately applicable. The receiving eNB shall consider the value of the ABS Information IE valid until reception of a new LOAD INFORMATION message carrying an update.
If an ABS indicated in the ABS pattern info IE coincides with a MBSFN subframe, the receiving eNB shall consider that the subframe is designated as almost blank subframe by the sending eNB.

These messages are used when an eNb performs ABS, that is reduces interference in certain subframes, to indicate another eNb about it. The other eNb can then take it into account in scheduling and make justifications for UE measurements to better account for the changes in interference conditions in CQI.
If the Invoke Indication IE is included in the LOAD INFORMATION message, it indicates which type of information the sending eNB would like the receiving eNB to send back. The receiving eNB may take such request into account.
If the Invoke Indication IE is set to “ABS Information”, it indicates the sending eNB would like the receiving eNB to initiate the Load Indication procedure, with the LOAD INFORMATION message containing the ABS Information IE indicating non-zero ABS patterns in the relevant cells.

This is used for asking about ABS patterns in the relevant cell.

### BRIEF DESCRIPTION OF THE DRAWINGS

FIG. 1 shows a message flow according to an embodiment of the invention;

FIG. 2 shows an apparatus according to an embodiment of the invention;

FIG. 3 shows a method according to an embodiment of the invention;

FIG. 4 shows an apparatus according to an embodiment of the invention;

FIG. 5 shows a method according to an embodiment of the invention;

FIG. 6 shows an apparatus according to an embodiment of the invention;

FIG. 7 shows a method according to an embodiment of the invention;

FIG. 8 shows an apparatus according to an embodiment of the invention; and

FIG. 9 shows a method according to an embodiment of the invention.

### DETAILED DESCRIPTION

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

Embodiments of the invention deal with signaling related to interference coordination which also works over a non-ideal backhaul.

It is an object of the present invention to improve the prior art. In particular, it is an object to optimize scheduling decisions in case of distributed scheduling.

According to a first aspect of the invention, there is provided apparatus for use in joint scheduling, the apparatus comprising a processing system configured to cause the apparatus to at least: calculate a joint schedule comprising a second schedule for serving a second user device using a resource by the apparatus and a first schedule for serving a first user device using the resource by a secondary transmission device different from the apparatus; and provide the joint schedule to the secondary transmission device, wherein the calculating is based on a second scheduling decision affecting information of the second user device and a first scheduling decision affecting information of the first user device, the first scheduling decision affecting information is received from the secondary transmission device and comprises a first quality information and a second quality information, the first quality information is considered to be based on a first muting assumption for the apparatus; the second quality information is considered to be based on a second muting assumption for the apparatus different from the first muting assumption; the second scheduling decision affecting information is received from the second user device and comprises a third quality information and a fourth quality information; the third quality information is considered to be based on a third muting assumption for the secondary transmission device; and the fourth quality information is considered to be based on a fourth muting assumption for the secondary transmission device different from the third muting assumption.

According to embodiments, there is provided an apparatus for use in joint scheduling, the apparatus comprising calculating means adapted to calculate a joint schedule comprising a second schedule for serving a second user device using a resource by the apparatus and a first schedule for serving a first user device using the resource by a secondary transmission device different from the apparatus; and providing means adapted to provide the joint schedule to the secondary transmission device, wherein the calculating is based on a second scheduling decision affecting information of the second user device and a first scheduling decision affecting information of the first user device, the first scheduling decision affecting information is received from the secondary transmission device and comprises a first quality information and a second quality information, the first quality information is considered to be based on a first muting assumption for the apparatus; the second quality information is considered to be based on a second muting assumption for the apparatus different from the first muting assumption; the second scheduling decision affecting information is received from the second user device and comprises a third quality information and a fourth quality information; the third quality information is considered to be based on a third muting assumption for the secondary transmission device; and the fourth quality information is considered to be based on a fourth muting assumption for the secondary transmission device different from the third muting assumption.

According to a second aspect of the invention, there is provided apparatus for use in joint scheduling, the apparatus comprising a processing system configured to cause the apparatus to at least: calculate a joint schedule comprising a second schedule for serving a second user device using a resource by the apparatus and a first schedule for serving a first user device using the resource by a secondary transmission device different from the apparatus; and provide the joint schedule to the secondary transmission device, wherein the calculating is based on a second scheduling decision affecting information of the second user device and a first scheduling decision affecting information of the first user device, the first scheduling decision affecting information is received from the secondary transmission device and comprises a first quality information and a second quality information, the first quality information is considered to be based on a first muting assumption for the apparatus; the second quality information is considered to be based on a second muting assumption for the apparatus different from the first muting assumption; the second scheduling decision affecting information comprises a third quality information and a fourth quality information; the third quality information is based on a second quality indicator received from the second user device and a third muting assumption for the secondary transmission device; and the fourth quality information is based on the second quality indicator and a fourth muting assumption for the secondary transmission device different from the third muting assumption.

According to embodiments, there is provided apparatus comprising calculating means adapted to calculate a joint schedule comprising a second schedule for serving a second user device using a resource by the apparatus and a first schedule for serving a first user device using the resource by a secondary transmission device different from the apparatus; and providing means adapted to provide the joint schedule to the secondary transmission device, wherein the calculating is based on a second scheduling decision affecting information of the second user device and a first scheduling decision affecting information of the first user device, the first scheduling decision affecting information is received from the secondary transmission device and comprises a first quality information and a second quality information, the first quality information is considered to be based on a first muting assumption for the apparatus; the second quality information is considered to be based on a second muting assumption for the apparatus different from the first muting assumption; the second scheduling decision affecting information comprises a third quality information and a fourth quality information; the third quality information is based on a second quality indicator received from the second user device and a third muting assumption for the secondary transmission device; and the fourth quality information is based on the second quality indicator and a fourth muting assumption for the secondary transmission device different from the third muting assumption.

According to a third aspect of the invention, there is provided a base station comprising apparatus according to the first or second aspects.

According to a fourth aspect of the invention, there is provided a system, comprising apparatus according to the first or second aspects, and at least one of the first user device and the second user device, wherein the at least one of the first user device and the second user device is a mobile phone.

According to a fifth aspect of the invention, there is provided apparatus for use in joint scheduling, the apparatus comprising a processing system configured to cause the apparatus to at least: provide, to a primary transmission device a first scheduling decision affecting information of a first user device, wherein the first scheduling decision affecting information comprises a first quality information and a second quality information, wherein the first quality information is received from the first user device and considered to be based on a first muting assumption for the primary transmission device, the second quality information is received from the first user device and considered to be based on a second muting assumption for the primary transmission device different from the first muting assumption.

According to embodiments, there is provided apparatus, comprising providing means adapted to provide, to a primary transmission device a first scheduling decision affecting information of a first user device, wherein the first scheduling decision affecting information comprises a first quality information and a second quality information, wherein the first quality information is received from the first user device and considered to be based on a first muting assumption for the primary transmission device, the second quality information is received from the first user device and considered to be based on a second muting assumption for the primary transmission device different from the first muting assumption.

According to a sixth aspect of the invention, there is provided apparatus for use in joint scheduling, the apparatus comprising a processing system configured to cause the apparatus to at least: provide, to a primary transmission device a first scheduling decision affecting information of a first user device, wherein the first scheduling decision affecting information comprises a first quality information and a second quality information, wherein the first quality information is based on a first quality indicator received from the first user device and on a first muting assumption for the primary transmission device, the second quality information is based on the first quality indicator and a second muting assumption for the primary transmission device different from the first muting assumption.

According to embodiments, there is provided apparatus, comprising providing means adapted to provide, to a primary transmission device a first scheduling decision affecting information of a first user device, wherein the first scheduling decision affecting information comprises a first quality information and a second quality information, wherein the first quality information is based on a first quality indicator received from the first user device and on a first muting assumption for the primary transmission device, the second quality information is based on the first quality indicator and a second muting assumption for the primary transmission device different from the first muting assumption.

According to a seventh aspect of the invention, there is provided a base station comprising apparatus according to the fifth or sixth aspects.

According to an eighth aspect of the invention, there is provided a system, comprising apparatus according to any of the fifth to seventh aspects, and the first user device, wherein the first user device is a mobile phone.

According to a ninth aspect of the invention, there is provided a method for use in joint scheduling, the method comprising calculating a joint schedule comprising a second schedule for serving a second user device using a resource by an apparatus performing the method and a first schedule for serving a first user device using the resource by a secondary transmission device different from the apparatus; and providing the joint schedule to the secondary transmission device, wherein the calculating is based on a second scheduling decision affecting information of the second user device and a first scheduling decision affecting information of the first user device, the first scheduling decision affecting information is received from the secondary transmission device and comprises a first quality information and a second quality information, the first quality information is considered to be based on a first muting assumption for the apparatus; the second quality information is considered to be based on a second muting assumption for the apparatus different from the first muting assumption; the second scheduling decision affecting information is received from the second user device and comprises a third quality information and a fourth quality information; the third quality information is considered to be based on a third muting assumption for the secondary transmission device; and the fourth quality information is considered to be based on a fourth muting assumption for the secondary transmission device different from the third muting assumption.

According to a tenth aspect of the invention, there is provided a method for use in joint scheduling, the method comprising calculating a joint schedule comprising a second schedule for serving a second user device using a resource by an apparatus performing the method and a first schedule for serving a first user device using the resource by a secondary transmission device different from the apparatus; and providing the joint schedule to the secondary transmission device, wherein the calculating is based on a second scheduling decision affecting information of the second user device and a first scheduling decision affecting information of the first user device, the first scheduling decision affecting information is received from the secondary transmission device and comprises a first quality information and a second quality information, the first quality information is considered to be based on a first muting assumption for the apparatus; the second quality information is considered to be based on a second muting assumption for the apparatus different from the first muting assumption; the second scheduling decision affecting information comprises a third quality information and a fourth quality information; the third quality information is based on a second quality indicator received from the second user device and a third muting assumption for the secondary transmission device; and the fourth quality information is based on the second quality indicator and a fourth muting assumption for the secondary transmission device different from the third muting assumption.

According to an eleventh aspect of the invention, there is provided a method for use in joint scheduling, the method comprising providing, to a primary transmission device a first scheduling decision affecting information of a first user device, wherein the first scheduling decision affecting information comprises a first quality information and a second quality information, wherein the first quality information is received from the first user device and considered to be based on a first muting assumption for the primary transmission device, the second quality information is received from the first user device and considered to be based on a second muting assumption for the primary transmission device different from the first muting assumption.

According to a twelfth aspect of the invention, there is provided a method for use in joint scheduling, the method comprising providing, to a primary transmission device a first scheduling decision affecting information of a first user device, wherein the first scheduling decision affecting information comprises a first quality information and a second quality information, wherein the first quality information is based on a first quality indicator received from the first user device and on a first muting assumption for the primary transmission device, the second quality information is based on the first quality indicator and a second muting assumption for the primary transmission device different from the first muting assumption.

Each of the methods of the ninth to twelfth aspects may be a method of joint scheduling.

According to a thirteenth aspect of the invention, there is provided a computer program product comprising a set of instructions which, when executed on a computerized device, is configured to cause the computerized device to carry out a method according to any of the ninth to twelfth aspects. The computer program product may be embodied as a computer-readable medium or directly loadable into the apparatus.

According to some embodiments of the invention, for example at least the following advantages are achieved: Jointly optimized scheduling decisions in case of distributed scheduling may be achieved. The solution is flexible to distribute control of the scheduling. The communication with non-CoMP UEs (e.g. CSI reporting) is not affected by the solution. The additional delay introduced by the optimized scheduling is rather small.

It is to be understood that any of the above modifications can be applied singly or in combination to the respective aspects to which they refer, unless they are explicitly stated as excluding alternatives.

Further features and advantages of the invention will become apparent from the following description of preferred embodiments of the invention, given by way of example only, which is made with reference to the accompanying drawings.

Hereinafter, without loss of generality, in this description, it is assumed that there are two transmission points. In general, there may be two or more transmission points. Sometimes, it is referred to the transmission points as eNodeBs in order to emphasize that these transmission points have their own scheduling entities (schedulers). Both transmission points have users for which the respective eNB is the serving point. Some of these users may be affected by strong interference from the other eNB.

According to embodiments of the invention, these users are configured to feed back two CQIs, one with muting assumption and one without muting assumption of the other point (more generally, one with a first muting assumption and one with a different second muting assumption for the other point). In general, with centralized scheduling, the muting and scheduling decisions for these two points may be calculated by optimizing the sum of the scheduling metrics of these two points. On the other hand, with independent scheduling, as the CQIs with muting assumption for the respective other point are larger than without muting assumption, the independent scheduling decisions of the two points would contradict, as both points would benefit from muting of the other point. By iteration, a system wise optimum or closer optimum scheduling decisions may be achieved. However, as each of the iterations adds a delay, it is beneficial if the joint scheduling is performed with a single iteration.

One or more of the following prerequisites are assumed in order to enable some embodiments of the invention:
Users in each transmission point are configured to report CQIs typical to a DPB scheme, i.e. two CQIs per reporting bandwidth, one with muting assumption and one with no muting assumption (or a different muting assumption) for the transmission point in the measurement set.
Each user reports its CQIs to its serving transmission point. The user may send the two CQIs to other points, too.
The user reports may have been triggered from the UE simultaneously or consecutively, or subframe subsets may be utilized to get the two CQIs with different muting assumptions.
Each eNB has its own scheduling unit and the transmission points are connected to each other, e.g. through a (modified) X2 interface (or an equivalent backhaul, which may be standardized).

There are several options as to how a UE can estimate a CQI under a muting assumption. In Rel 11 standard, a CSI process is defined which means that a CSI-RS and CSI-IM are assigned to a UE. The CSI-RS is used to measure the channel between a transmission point and the UE, and the CSI-IM is used to measure the interference according to an interference assumption. Thus, in a case of two CQIs with different muting assumptions being required, the UE is configured with two CSI processes that have the same CSI-RS (transmission point is the same) and different CSI-IMs. The network is responsible for arranging the traffic such that the UE sees the intended interference from the CSI-IM, which are zero power RS, thus holes where the UE sees residual interference according to the interference assumption of that process.

According to another option, which is not standardized but has been discussed in 3GPP, one CSI-RS process is configured in the UE with one CSI-RS and one CSI-IM from which the UE sees out of CoMP set interference (equivalent to the muted CQI assumption). Then the UE uses a parameter alpha with which the UE emulates the non-muted CQI assumption. In this case, the UE is configured also with CSI-RS from the other point and that measurement can be used together with the scaling term alpha to emulate the interference from the other point.

According to embodiments of the invention, a distributed coordinated scheduling (virtual joint scheduling) is provided, as follows: A primary entity (transmission point, eNB) is selected and it performs its joint scheduling decisions according to information received from one or more coordinating secondary entities (transmission points, eNBs). It may also take into account information received from user equipments served by the primary entity. The primary entity then forwards information of its joint scheduling decisions or some outcome quantity to the one or more secondary entities, each of which may perform their own localized scheduling decisions based on the information provided by the primary entity.

In more detail, according to embodiments of the invention, some or all the following steps are performed:
1. One (or more) eNB (s) is selected as a primary eNB. One or more other eNB s are selected as secondary eNB(s). This selection can be carried out based on request or based on implicit or explicit signalling between the entities. Any selection method may be applied.
2. The secondary eNBs transmit the relevant scheduling decision-affecting information (e.g. both the muted and non-muted CQI, and potentially additionally ABS pattern, DL/UL traffic pattern, load information) of their users to the primary eNB.
3. The primary eNB receives the scheduling decision-affecting information of secondary eNBs and uses the information to make a jointly optimum scheduling for muting assumptions without iterations.
4. After this joint scheduling in the primary eNB, the primary eNB forwards the outcome of the scheduling to the secondary eNBs. This scheduling outcome can be for example muting patterns for the participating eNBs which can be time domain muting patterns or frequency domain (per PRB/subband) muting patterns; in general, the scheduling outcome may be of any type as far as the secondary eNBs may derive the intended scheduling (jointly optimum scheduling) from it. For example, the scheduling outcome may comprise RNTPs for the primary and secondary eNBs but is not limited to RNTPs.
5. After receiving the outcome of the joint scheduling, the secondary eNBs (may) perform their own localized scheduling decisions according to the scheduling information received from the primary eNB (e.g. muting patterns based on the joint scheduling outcome).
6. After the scheduling has been done, the procedure may restart from bullet point 1, i.e. the selection of the primary eNB may be performed again. Namely, according to some embodiments, the primary eNB in the system is fixed. In this case, the procedure may restart from bullet point 2. In some embodiments, the primary eNB may be changed. In this case, the procedure restarts from bullet point 1.

According to embodiments of the invention, the italic quantities are signaled through (modified) X2 or equivalent backhaul. Also, any type of scheduling outcome may be applied.

According to embodiments of the invention, instead of or in addition to the muted and non-muted CQIs, the information exchange from secondary to primary entities may comprise other information, for example the respective scheduling metrics directly, wherein at least two metrics per user per scheduling unit with different muting/transmission assumptions are transmitted from the secondary entity (or entities) entities to the primary entity (or entities), corresponding to expecting different levels of cooperation from the other transmission point.

Normal single cell scheduling metric/CQI information of users that are not in CoMP mode do not need to be exchanged, but in some embodiments may be exchanged, too. The single cell scheduling of users in legacy mode may occur independently in all transmission points. When an eNB receives the muting pattern it may carry out scheduling with current single user CSI information and the jointly coordinated CoMP information. Consequently, the delay caused by jointly coordinating the scheduling affects only CoMP users which may be further picked by, for example, their QoS.

Embodiments of the invention may be used in homogeneous networks where two eNBs (transmission points) cooperate. In this case, the transmission points may switch their turns as primary transmission point to ensure fairness in the system. In heterogeneous schemes with distributed scheduling units, a macro-node is a natural primary transmission point making the joint decisions and forwarding the outcome. However, even in this case, according to embodiments of the invention, a pico node may be the primary transmission point.

Embodiments of the invention may be applied to an X2 interface modified over that of Rel-11 or a similar interface. Changes in the X2 specification over that of Rel-11 include CQI information exchange and muting patterns for all cooperating transmission points (or corresponding information as outlined hereinabove). According to Rel-11, only own muting patterns may be signaled.

The number of primary eNBs is typically one, but according to some embodiments of the invention, there may be more than one primary eNB, for example in heterogeneous cases. In such a case, the secondary eNBs would act according to the information received from one or more than one of the primary eNBs. In that kind of network, there may be certain rules or configurations on the priority order of the primary points.

The procedures of the eNBs according to some embodiments of the invention are as follows:
1. All eNBs receive CSI feedback from the configured UEs.
   i. Configuration comprises the request for multiple, at least two, CSI processes feedback. Multiple CSI processes feedback imply different interference hypotheses for the UE. A special CSI feedback may be based on one CSI process configured with multiple interference hypotheses in TDM, for example. One special case is assuming muting of the other transmission point.
2. A secondary eNB sends the CQI information/scheduling metrics to the primary eNB.
3. The primary eNB, making the joint scheduling, receives the CQI information/scheduling metrics from secondary eNB, and calculates a joint scheduling scheme.
4. The primary eNB informs the secondary eNB(s) of the following information:
   i. The joint scheduling scheme or a corresponding information (scheduling outcome);
   ii. optionally about the muting/interference coordination assumption of the scheduling outcome
5. The secondary eNB performs localized scheduling by taking into account the indicated joint scheduling/CSI feedback from the primary eNB.

The role of the primary eNB may also change after the signaling.

The primary transmission point may schedule its UEs according to the outcome of the joint scheduling. In some embodiments, it may additionally adapt the joint scheduling to optimize its own scheduling, e.g. in view of non-CoMP UEs.

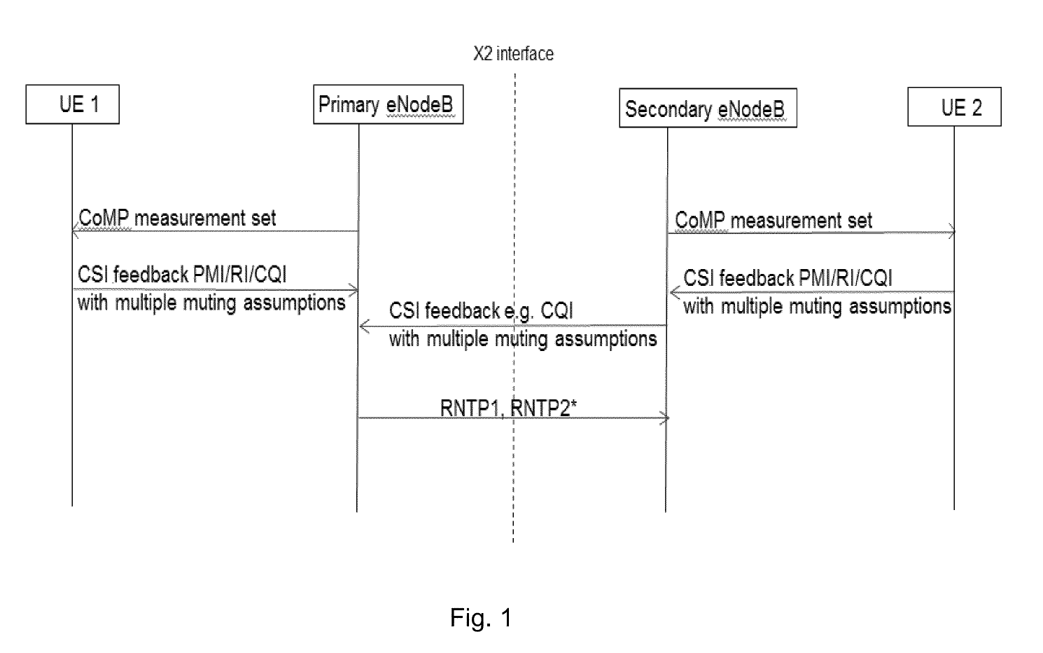

A message flow according to an embodiment of the invention is shown in FIG. 1. In the example of FIG. 1 it is assumed that each eNB configures the UEs in its coverage area with single or multiple CSI processes, i.e. in single user or CoMP mode. In the example, the two UEs shown are both in CoMP mode. Therefore, they provide CoMP measurement results to their respective eNodeBs according to their configured CoMP measurement set. In addition, they may provide RRM measurement results according to the configured RRM measurement set (not shown). Each of the two UEs provides CQIs with different muting assumptions (such as no muting and muting of the non-serving eNB) to each serving eNB. The different CQIs may be provided in a single message as shown or in different messages with an arbitrary sequence.

According to Rel-11 specification, the eNBs may inform the other eNBs of their Relative Narrowband Tx Power (RNTP) which is equivalent to indicating their own muting (or power control) per subband at a particular time. The delay of sending such information can be of N ms, where N depends of the backhaul quality. In case an X2 interface is used for the exchange of RNTP, a delay of 10 ms may for example be assumed. This conventional exchange of RNTP is not required according to some embodiments of the invention.
One of the eNBs is declared as primary eNB and it performs joint scheduling for both eNBs. More precisely, the primary eNB performs scheduling for users anchored to it whilst taking into account the scheduling metrics from the secondary eNB(s).
   The joint scheduling decision outcome, e.g. muting patterns in the form of RNTP1 and RNTP2*, is informed to the secondary eNB (eNB2). RNTP2* means a proposal for the muting patterns of eNB2 according to the joint scheduling. RNTP2* is not a measured or set value, but may be used by eNB2 to allocate its own scheduled UEs (i.e. to calculate its own schedule).
   In order to provide a fair interference coordination mechanism, the role of primary eNB may change over time.
   The round trip time of such master-slave scheduling is increased to 2×N compared to the simple RNTP indication.
   In some embodiments, in a different instance, each eNB may perform single cell scheduling. In these embodiments, only the feedback characterizing the CoMP users may be sent to the other eNBs. Such feedback may consist of the scheduler metric, CSI feedback in the form of CQI/PMI/RI and/or other feedback quantities characterizing the UEs.

With simple RNTP indication, joint scheduling decisions may not be possible if the CQI information and scheduling units are distributed.

A main difference according to embodiments of the invention to EP2503837A1 is that secondary transmission points may have their own scheduling intelligence (distributed scheduling intelligence) such that each eNB performs its own final scheduling. A main difference according to embodiments of the invention to US2012/0238283A1 is that no (virtual or any) joint scheduling is involved according to this prior art.

According to some embodiments, the UE provides only a single CQI (typically the nonmuted CQI, i.e. the CQI as measured without any muting assumption applied thereto) to its eNB. Then, an eNB calculates out of this single CQI value another CQI value with a different muting assumption. Also, an eNB may further tune the nonmuted CQI, thus an eNB may derive two CQIs out of one reported CQI. For this, an eNB may e.g. scale the nonmuted CQI, based on previous muted CQI reports, from which it may estimate the effect of muting. In addition or instead, it may take CQI measurements of other UEs, potentially with respective location information, into account in order to determine the muting effect. If the eNB is a secondary eNB, it provides these two CQIs (i.e. the received one and the calculated one, or two calculated ones based on different muting assumptions) to the primary eNB. If the eNB is the primary eNB, it calculates the schedules using these two CQIs.

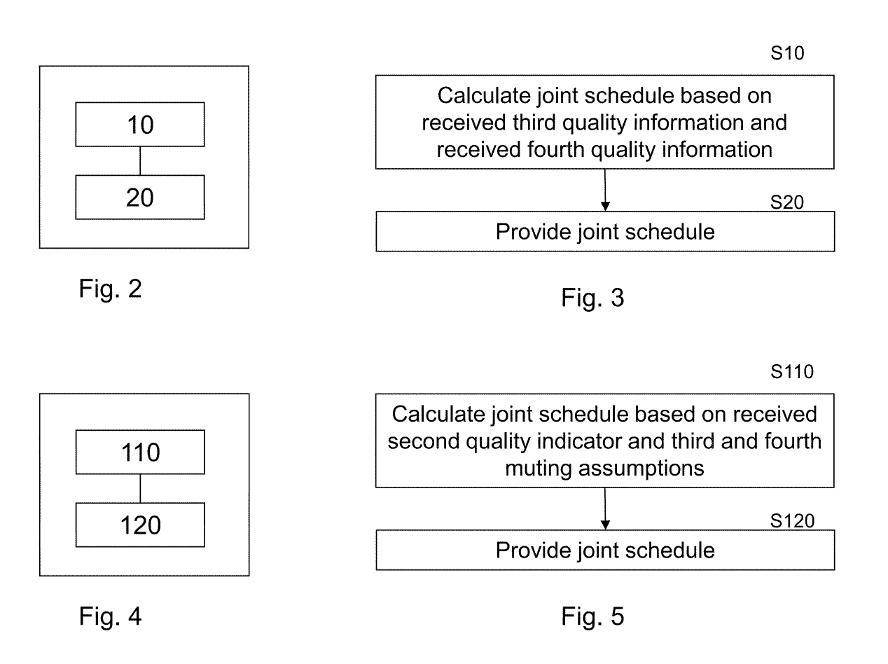

FIG. 2 shows an apparatus according to an embodiment of the invention. The apparatus may be a primary transmission device such as an eNB or a part thereof. FIG. 3 shows a method according to an embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises a processing system and/or at least one processor 10 and at least one memory 20. The at least one memory 20 includes computer program code, and the at least one processor 10, with the at least one memory 20 and the computer program code is arranged to cause the apparatus to perform calculating (S10) a joint schedule comprising a second schedule for serving a second user device using a resource by the apparatus and a first schedule for serving a first user device using the resource by a secondary transmission device different from the apparatus; and providing (S20) the joint schedule to the secondary transmission device.

The calculating (S10) is based on a second scheduling decision affecting information received from the second user device and a first scheduling decision affecting information of the second user device received from the secondary transmission device.

The second scheduling decision affecting information comprises a third quality information (e.g. CQI with no muting) and a fourth quality information (e.g. estimated CQI under muting assumption for the secondary transmission device). The third and fourth quality informations are considered to be based on different muting assumptions for the secondary transmission device.

The first scheduling decision affecting information substantially corresponds to the first scheduling decision affecting information. That is, it comprises a first quality information (e.g. CQI with no muting) and a second quality information (e.g. estimated CQI under muting assumption for the apparatus). The first and second quality informations are considered to be based on different muting assumptions for the apparatus.

FIG. 4 shows an apparatus according to an embodiment of the invention. The apparatus may be a primary transmission device such as an eNB or a part thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises a processing system and/or at least one processor 110 and at least one memory 120. The at least one memory 120 includes computer program code, and the at least one processor 110, with the at least one memory 120 and the computer program code is arranged to cause the apparatus to perform calculating (S110) a joint schedule comprising a second schedule for serving a second user device using a resource by the apparatus and a first schedule for serving a first user device using the resource by a secondary transmission device different from the apparatus; and providing (S120) the joint schedule to the secondary transmission device.

The calculating (S10) is based on a second scheduling decision affecting information of the second user device and a first scheduling decision affecting information of the second user device received from the secondary transmission device.

The second scheduling decision affecting information comprises a third quality information (e.g. CQI with no muting) and a fourth quality information (e.g. scaled CQI under muting assumption for the secondary transmission device). The third quality information is based on a second quality indicator received from the second user device and a third muting assumption for the secondary transmission device; and the fourth quality information is based on the second quality indicator and a fourth muting assumption for the secondary transmission device different from the third muting assumption. I.e., the third and fourth quality informations are based on the same second quality indicator and the third and fourth muting assumptions for the secondary transmission device, respectively, which are considered to be different.

The first scheduling decision affecting information substantially corresponds to the first scheduling decision affecting information. That is, it comprises a first quality information (e.g. CQI with no muting) and a second quality information (e.g. estimated CQI under muting assumption for the apparatus). The first and second quality informations are considered to be based on different muting assumptions for the apparatus.

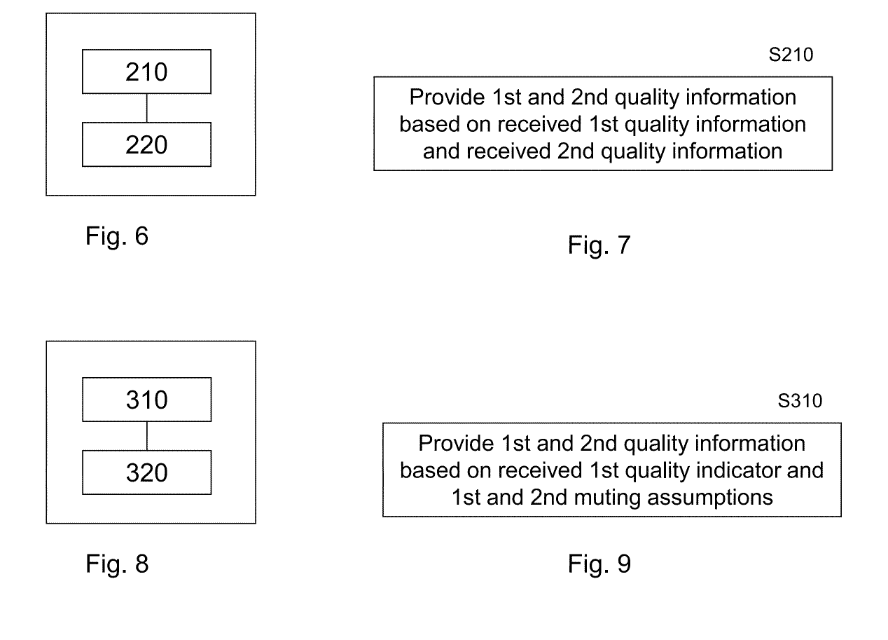

FIG. 6 shows an apparatus according to an embodiment of the invention. The apparatus may be a secondary transmission device such as an eNB or a part thereof FIG. 7 shows a method according to an embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises a processing system and/or at least one processor 210 and at least one memory 220. The at least one memory 220 includes computer program code, and the at least one processor 210, with the at least one memory 220 and the computer program code is arranged to cause the apparatus to perform providing (S210), to a primary transmission device, a first scheduling decision affecting information of a first user device.

The first scheduling decision affecting information comprises a first quality information and a second quality information, each of which being received from the first user device. The first quality information (e.g. CQI with no muting) is considered to be based on a first muting assumption (e.g. no muting of the primary transmission device) for the primary transmission device. The second quality information (e.g. CQI with muting of the primary transmission device) is considered to be based on a second muting assumption for the primary transmission device different from the first muting assumption.

FIG. 8 shows an apparatus according to an embodiment of the invention. The apparatus may be a secondary transmission device such as an eNB or a part thereof FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises a processing system and/or at least one processor 310 and at least one memory 320. The at least one memory 320 includes computer program code, and the at least one processor 310, with the at least one memory 320 and the computer program code is arranged to cause the apparatus to perform providing (S310), to a primary transmission device, a first scheduling decision affecting information of a first user device.

The first scheduling decision affecting information comprises a first quality information and a second quality information. The first quality information is based on a first quality indicator received from the first user device and on a first muting assumption for the primary transmission device, and the second quality information is based on the first quality indicator and a second muting assumption for the primary transmission device different from the first muting assumption. That is, both the first and second quality information are based on the same received first quality indicator and the first and second muting assumptions for the primary transmission device, respectively.

In addition, according to some embodiments of the invention, the processing system and/or at least one processor 210, 310 and the at least one memory 120, 220 may be arranged to cause the apparatus to perform calculating a calculated schedule for serving the first user device using a resource such as a radio interface based on a joint schedule received from the primary transmission device; and scheduling the calculated schedule for serving the user device using the resource. The joint schedule received from the primary transmission device comprises a primary schedule for the primary transmission device and a proposed schedule for serving the first user device by the apparatus.

Muting assumptions are e.g. complete muting, muting of some channels or physical resource blocks, power limiting on some or all channels or physical resource blocks, and no muting.

Instead of a CQI, other quality indicators such as a CQI difference or a scheduling metric may be used. Typically, these quality indicators are based on a SINR, and a difference of SINR for different muting assumptions is evaluated.

Embodiments of the invention are described, wherein a radio resource is scheduled. According to embodiments of the invention, instead of or in addition to the radio resource, a resource on one or more wires may be scheduled.

A physical resource block of the resource is a combination of time interval, frequency interval, and code. A channel may comprise one or more PRBs.

Embodiments of the invention are described, wherein channel quality indicators with different muting assumptions are used as quality information. According to some embodiments of the invention, instead of or in addition to a channel quality indicator, at least one of a downlink/uplink traffic exchange, an almost blank subframe pattern, and a modulation type may be used.

Embodiments of the invention are described based on an LTE-A system but embodiments of the invention may be applied to other radio access technologies such as LTE, WiFi, WLAN, UMTS, HSPA, if joint scheduling may be employed.

A user device (also named terminal) terminal may be a machine type device, a user equipment, a mobile phone, a laptop, a smartphone, a tablet PC, or any other device that may attach to a mobile network. A base station may be a NodeB, an eNodeB or any other base station of a radio network.

If not otherwise stated or otherwise made clear from the context, the statement that two entities are different means that they are differently addressed in their respective network(s). It does not necessarily mean that they are based on different hardware. That is, each of the entities described in the present description may be based on a different hardware, or some or all of the entities may be based on the same hardware.

According to the above description, it should thus be apparent that example embodiments of the present invention provide, for example a base station or a component thereof, an apparatus such as a server embodying the same, a method for controlling and/or operating the same, and computer program(s) controlling and/or operating the same as well as mediums carrying such computer program(s) and forming computer program product(s).

According to example embodiments of the present invention, a system may comprise any conceivable combination of the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software/firmware or by hardware without changing the ideas of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for use in joint scheduling, the apparatus comprising a processing system, the processing system comprising at least one processor and at least one memory storing computer program code, in which the processing system is configured to cause the apparatus to at least:
calculate a joint schedule comprising a second schedule for serving a second user device using a resource by the apparatus and a first schedule for serving a first user device using the resource by a secondary transmission device different from the apparatus; and
provide the joint schedule to the secondary transmission device,
wherein:
the calculating is based on a second scheduling decision affecting information of the second user device and a first scheduling decision affecting information of the first user device,
the first scheduling decision affecting information is received from the secondary transmission device and comprises a first quality information and a second quality information,
the first quality information is based on a first muting assumption for the apparatus,
the second quality information is based on a second muting assumption for the apparatus different from the first muting assumption,
the second scheduling decision affecting information comprises a third quality information and a fourth quality information,
the third quality information is based on a third muting assumption for the secondary transmission device, and
the fourth quality information is based on a fourth muting assumption for the secondary transmission device different from the third muting assumption.

2. The apparatus according to claim 57, wherein:
the third quality information is based on a third measuring by the second user device, wherein the third measuring comprises measuring a third quality of a second channel of the resource between the apparatus and the second user device under the third muting assumption; and
the fourth quality information is based on a fourth measuring by the second user device, wherein the fourth measuring comprises measuring a fourth quality of the second channel under the fourth muting assumption.

3. (canceled)

4. The apparatus according to claim 58, wherein the second quality indicator is based on a sixth measuring by the second user device, and the sixth measuring comprises measuring a sixth quality of a second channel of the resource between the apparatus and the second user device.

5. The apparatus according to claim 1, wherein:
the first quality information is based on a first measuring by the first user device,
the first measuring comprises measuring a first quality of a first channel of the resource between the secondary transmission device and the first user device under the first muting assumption,
the second quality information is based on a second measuring by the first user device, and
the second measuring comprises measuring a second quality of the first channel under the second muting assumption.

6. The apparatus according to claim 1, wherein the first quality information and the second quality information are based on a fifth measuring by the first user device, and the fifth measuring comprises measuring a fifth quality of a first channel of the resource between the secondary transmission device and the first user device.

7. The apparatus according to claim 1, the processing system being configured to cause the apparatus to perform the calculating based on at least one of a channel quality indicator of the second user device, a downlink/uplink traffic exchange of the apparatus, an almost blank subframe pattern of the apparatus, a modulation type of the apparatus, a channel quality indicator of the first user device, a downlink/uplink traffic exchange of the secondary transmission device, an almost blank subframe pattern of the secondary transmission device, and a modulation type of the secondary transmission device.

8-9. (canceled)

10. The apparatus according to claim 1, wherein the first scheduling decision affecting information is received from the secondary transmission device over one of a backhaul and an air interface.

11. The apparatus according to claim 1, wherein the joint schedule is provided to the secondary transmission device over one of a backhaul and an air interface.

12-16. (canceled)

17. An apparatus for use in joint scheduling, the apparatus comprising a processing system, the processing system comprising at least one processor and at least one memory storing computer program code, in which the processing system is configured to cause the apparatus to at least provide, to a primary transmission device, a first scheduling decision affecting information of a first user device,
wherein:
the first scheduling decision affecting information comprises a first quality information and a second quality information,
the first quality information is received from the first user device and is based on a first muting assumption for the primary transmission device, and
the second quality information is received from the first user device and is based on a second muting assumption for the primary transmission device different from the first muting assumption.

18-30. (canceled)

31. A method for use in joint scheduling, the method comprising:
calculating a joint schedule comprising a second schedule for serving a second user device using a resource by an apparatus performing the method and a first schedule for serving a first user device using the resource by a secondary transmission device different from the apparatus; and
providing the joint schedule to the secondary transmission device,
wherein:
the calculating is based on a second scheduling decision affecting information of the second user device and a first scheduling decision affecting information of the first user device,
the first scheduling decision affecting information is received from the secondary transmission device and comprises a first quality information and a second quality information,
the first quality information is based on a first muting assumption for the apparatus,
the second quality information is based on a second muting assumption for the apparatus different from the first muting assumption,
the second scheduling decision affecting information comprises a third quality information and a fourth quality information,
the third quality information is based on a third muting assumption for the secondary transmission device, and
the fourth quality information is based on a fourth muting assumption for the secondary transmission device different from the third muting assumption.

32. The method according to claim 31, wherein:
the third quality information is based on a third measuring by the second user device,
the third measuring comprises measuring a third quality of a second channel of the resource between the apparatus and the second user device under the third muting assumption,
the fourth quality information is based on a fourth measuring by the second user device, and
the fourth measuring comprises measuring a fourth quality of the second channel under the fourth muting assumption.

33. (canceled)

34. The method according to claim 59, wherein the second quality indicator is based on a sixth measuring by the second user device, and the sixth measuring comprises measuring a sixth quality of a second channel of the resource between the apparatus and the second user device.

35. The method according to claim 31, wherein:
the first quality information is based on a first measuring by the first user device,
the first measuring comprises measuring a first quality of a first channel of the resource between the secondary transmission device and the first user device under the first muting assumption,
the second quality information is based on a second measuring by the first user device, and
the second measuring comprises measuring a second quality of the first channel under the second muting assumption.

36. The method according to claim 31, wherein the first quality information and the second quality information are based on a fifth measuring by the first user device, and the fifth measuring comprises measuring a fifth quality of a first channel of the resource between the secondary transmission device and the first user device.

37. The method according to claim 31, wherein the calculating is based on at least one of a channel quality indicator of the second user device, a downlink/uplink traffic exchange of the apparatus, an almost blank subframe pattern of the apparatus, a modulation type of the apparatus, a channel quality indicator of the first user device, a downlink/uplink traffic exchange of the secondary transmission device, an almost blank subframe pattern of the secondary transmission device, and a modulation type of the secondary transmission device.

38-41. (canceled)

42. The method according to claim 31, wherein the joint schedule comprises a second relative narrowband transmit power message describing a muting assumption for the apparatus and a first relative narrowband transmit power message describing a muting assumption for the secondary transmission device.

43-56. (canceled)

57. The apparatus according to claim 1, wherein the second scheduling decision affecting information is received from the second user device.

58. The apparatus according to claim 1, wherein the third quality information and fourth quality of information are further based on a second quality indicator received from the second user device.

59. The method according to claim 31, wherein the second scheduling decision affecting information is received from the second user device.

60. The method according to claim 31, wherein the third quality information and fourth quality of information are further based on a second quality indicator received from the second user device.
